(19) United States
(12) Patent Application Publication
(10) Pub. No.: US 2025/0259071 A1
(43) Pub. Date: Aug. 14, 2025

(54) EXPLOIT LORA MODULES FOR NEAR OOD

(71) Applicant: Oracle International Corporation, Redwood Shores, CA (US)

(72) Inventors: Etienne Salimbeni, Zurich (CH); Renata Khasanova, Zurich (CH); Milos Vasic, Zurich (CH)

(21) Appl. No.: 18/905,455

(22) Filed: Oct. 3, 2024

Related U.S. Application Data
(60) Provisional application No. 63/551,243, filed on Feb. 8, 2024.

(51) Int. Cl. G06N 3/091; G06N 3/04

(52) U.S. Cl. CPC G06N 3/091; G06N 3/04

(57) ABSTRACT

Here is out of distribution (OOD) detection of an input token sequence for a large language model (LLM). A finetuning factor matrix is used for Mahalanobis measurement of transformer layer activation in the LLM. A computer generates a first token embedding based on: a factor matrix and an output of a first neural layer that represents a first token in a sequence of tokens. Into a multi-token embedding, the first token embedding is combined with a second token embedding that is based on: the factor matrix and a second token in the sequence of tokens. Based on a second neural layer, a second multi-token embedding that represents the sequence of tokens is generated. Into a multilayer embedding, the first multi-token embedding and the second multi-token embedding are concatenated. The sequence of tokens is classified as OOD based on statistical analysis of the multilayer embedding.

### CROSS-REFERENCE TO RELATED APPLICATION; BENEFIT CLAIM

This application claims the benefit of Provisional Application 63/551,243, filed Feb. 8, 2024, the entire contents of which are hereby incorporated by reference as if fully set forth herein, under 35 U.S.C. § 119 (e).

### FIELD OF THE INVENTION

The present invention relates to out of distribution (OOD) detection of an input token sequence for a large language model (LLM). A finetuning factor matrix is used for Mahalanobis measurement of transformer layer activation in the LLM.

### BACKGROUND

Out-Of-Distribution (OOD) detection deals with detecting data that differs from an expected data distribution. For a machine learning (ML) model, this means detecting input data that is outside of the data distribution on which the model was trained. State of the art OOD detection faces challenges when an OOD input to an ML model is semantically near (i.e. somewhat similar) to the training dataset, a situation referred to herein as near OOD. For example, a language model may have been trained to summarize news articles. The language model's behavior readily distinguishes a request to summarize a book, which is outside its training scope, but the language model's behavior does not differentiate an amateur online post about politics. This is problematic because an ML model tends to perform worse as its inputs increasingly deviate from its training dataset. Additionally, near OOD accuracy may be jeopardized by several kinds of changes that may occur across multiple patches and releases of a curated ML model. When designing prompts for a language model application, even a minor update in the model can affect the application's reliability.

State of the art far (i.e. not near) OOD detection relies on scores such as perplexity and logit or relies on a slow and non-repeatable technique such as Monte-Carlo (i.e. randomization). K-nearest neighbors (KNN) may provide a state of the art OOD score by measuring the distance to the kth nearest neighbor in a training set. It has been shown that state of the art metrics based on perplexity and logits are inadequate when the OOD input semantics closely resemble the training dataset. Recent research has addressed some limitations of OOD methods in the context of near OOD. State-of-the-art approaches typically rely on an external dataset as a reference against which to compare a new input, which can be challenging to generalize and may not be feasible to generate for all tasks.

### BRIEF DESCRIPTION OF THE DRAWINGS

In the drawings:

FIG. 1 is a block diagram that depicts an example computer that performs out of distribution (OOD) detection for a sequence of tokens that a large language model (LLM) accepts as input;

FIG. 2 is a flow diagram that depicts an example computer process that detects whether or not a sequence of tokens is OOD;

FIG. 3 is a flow diagram that depicts an example computer process that finetunes and compares different versions of an LLM;

FIG. 4 is a block diagram that illustrates a computer system upon which an embodiment of the invention may be implemented;

FIG. 5 is a block diagram that illustrates a basic software system that may be employed for controlling the operation of a computing system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Herein is out of distribution (OOD) detection of an input token sequence for a large language model (LLM). For high-stakes applications that increasingly rely on LLMs, this approach addresses security concerns that arise regarding reliability and safe integration and addresses significant challenges in activity monitoring, verifying model versions, and making decisions about halting a model's operations. The approach herein is based on an LLM lifecycle that splits model training into a pretraining phase followed by a finetuning phase, and novel finetuning instrumentation records machine learning metadata that can be used to quickly compare a new input to the totality of what application specifics the model learned during finetuning. A finetuning factor matrix is used for Mahalanobis measurement of transformer layer activation in the LLM.

This approach has at least the following innovations. This approach detects near OOD, unlike the state of the art discussed in the above Background. Because subtle behavioral changes between model versions manifest as near OOD, this approach is suitable for acceptance testing and quality control, unlike the state of the art. The unprecedented accuracy of this approach is well suited for model selection and, in a production environment, admission control of an input prompt. If a prompt is OOD, the prompt is rejected and no response inferred by the LLM is provided to a user or downstream automation. This approach does not rely on an external dataset such as a reference corpus.

This approach may begin, for example, with a huge LLM that was already pretrained to perform various generalized NLP tasks such as translation, question answering, and text generation. Finetuning typically occurs in an environment that has less computational resources and capacity than was used for pretraining. Due to computer resource constraints and for additional reasons herein, the LLM herein is finetuned using Parameter Efficient Fine Tuning (PEFT) that entails Natural Language Processing (NLP) techniques that increase performance (i.e. accuracy) of an LLM above what pretraining already achieved. Instead of finetuning all learnable model parameters (i.e. neural connection weights), PEFT focuses on a much smaller subset, referred to herein as factor matrices, that saves time and space of the finetuning computer. During finetuning, PEFT herein freezes most of the pretrained model's parameters, essentially keeping them unchanged, and this avoidance of parameter modifications accelerates the finetuning computer. PEFT herein adds a small number of new trainable parameters specifically relevant to finetuning. Finetuning only these few new parameters, along with a carefully chosen subset of the pretrained model's parameters, accelerates finetuning without decreasing accuracy.

General benefits of PEFT herein include at least the following.
Reduced Computational Cost: Training requires less processing power and memory compared to full finetuning, making it more accessible on resource-constrained hardware.
Overcoming Catastrophic Forgetting: This is a phenomenon where a model forgets its original pretrained capabilities after finetuning for a new task. PEFT helps mitigate this issue by preserving most of the pre-trained knowledge.
Improved Performance in Low-Data Regimes: PEFT can be effective even with limited training data for the specific task.
Better Generalization: Models trained with PEFT can sometimes generalize better to unseen data compared to fully finetuned models.

Novel retention and use of factor matrices to generate novel token embeddings (i.e. encodings) of an input sequence provide the following computer performance increases as special benefits. The overall accuracy of OOD detection herein is unprecedented (i.e. increased). For near OOD that is near a novel decision boundary, accuracy is unprecedented. For example unlike this approach, state of the art OOD detection is prone to false negatives near a state of the art decision boundary. In other words, increase of the true positive rate (TPR) herein is unprecedented. In those ways, increase of the accuracy of internal operation of an OOD detection computer is increased above the state of the art.

Herein, a novel use of OOD detection is acceptance testing to decide whether a new version of an LLM is at least as reliable as a previous version of the LLM. Regardless of whether an acceptance test herein passes or fails: a) the more accurate version of the LLM is selected, and b) the effect of that model selection is that the accuracy of the NLP computer is maximized. Thus, regardless of whether the acceptance test passes or fails, the accuracy of the NLP computer is increased by validation herein based on novel embeddings of tokens and novel hierarchical embeddings derived by aggregation of multiple embeddings. In other words, regardless of whether the acceptance test passes or fails, the embedding-based acceptance testing herein is a new way to increase the accuracy of internal operation of the NLP computer.

### 1.0 Example Computer

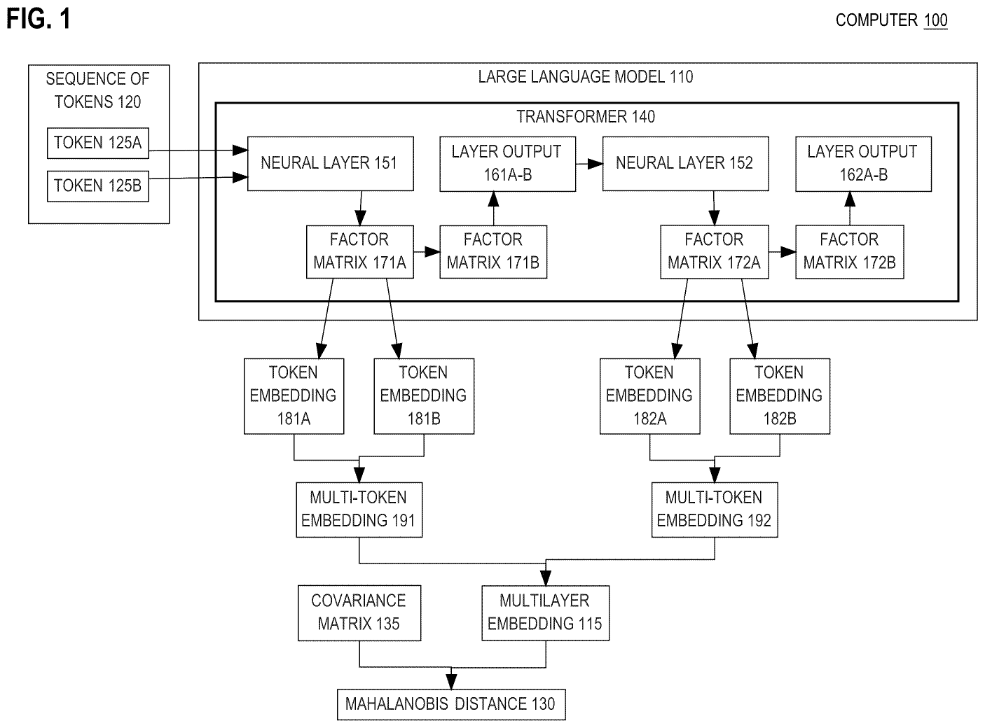

FIG. 1 is a block diagram that depicts an example computer 100 that performs out of distribution (OOD) detection for sequence of tokens 120 that large language model (LLM) 110 accepts as input. Computer 100 uses finetuning factor matrices 171A and 172A for generating embeddings 115, 181A-B, 182A-B, and 191-192 and layer outputs 161A-B and 162A-B in transformer 140. Computer 100 may be one or more of a rack server such as a blade, a personal computer, a mainframe, or a virtual computer. All of the components shown in FIG. 1 may be stored and operated in volatile or nonvolatile storage of computer 100.

### 1.1 Transformer Architecture

Sequence of tokens 120 contains many tokens 125A-B that, in an embodiment, may be lexical tokens such as words in a natural language prompt that LLM 110 accepts as input. LLM 110 is a machine learning model that contains transformer 140 that is a multilayer artificial neural network. A transformer has parallel attention, which is unlike a recurrent neural network that is serial. In various embodiments, transformer 140 may comprise a unidirectional transformer such as a generalized pretrained transformer (GPT) or a bidirectional encoder representations from transformers (BERT).

Although not shown, LLM 110 may contain a (e.g. generative) decoder that is a machine learning model that accepts, as input, the output inferred by transformer 140. In an embodiment, LLM 110 is an artificial neural network.

Transformer 140 contains a sequence of neural layers 151-152. Each of neural layers 151-152 may be a single neural layer or a subsequence of multiple neural layers such as a transformer module having parallel attention.

Each neural layer accepts a sequence of encoded or unencoded tokens as input and, in cooperation with a pair of factor matrices as discusses later herein, inferentially generates an encoded sequence of tokens as output. Each output token represents a corresponding input token. The output sequence of tokens represents the input sequence of tokens. For example, neural layer 151 accepts sequence of tokens 120 as input, which causes neural layer 151, in cooperation with factor matrices 171A-B as discusses later herein, to inferentially generate an encoded sequence of tokens that contains encoded tokens shown as layer outputs 161A-B that respectively represent tokens 125A-B. Likewise, neural layer 152 accepts layer outputs 161A-B as input, which causes neural layer 152, in cooperation with factor matrices 172A-B as discusses later herein, to inferentially generate layer outputs 162A-B.

In an embodiment: a) transformer 140 contains multiple transformer modules, b) each of neural layers 151-152 is a distinct multilayer transformer module, and c) an output of one transformer module contains layer outputs 161A-B, and an output of another transformer module contains layer outputs 162A-B.

1.2 Finetuning after Pretraining that Already Occurred

Herein, LLM 110 already was pretrained and later also already was finetuned and, for example, neither the pretraining nor the finetuning were performed by computer 100. Pretraining is extremely computer resource intensive and consumes much computation time (i.e processor cycles), much computer storage space for a huge training corpus, and these consume much electricity. Pretraining caused LLM 110 to be accurate at general purpose tasks but not for special (i.e. application specific) tasks.

Finetuning uses an application specific finetuning corpus that is multiple orders of magnitude smaller than the pretraining corpus. However, naïve finetuning still is very computer resource intensive because transformer 140 may have hundreds of millions of neural connection weights that may be individually adjusted by naïve finetuning, which would take many hours of computation. For example, electricity consumption of BERT finetuning is measured in kilowatt hours.

1.2 Parameter Efficient Fine Tuning (PEFT) with Factor Matrices

Herein, parameter efficient fine tuning (PEFT) operates as follows. Each of neural layers 151-152 contains a distinct connection weight matrix (not shown), and naïve finetuning may adjust many or all of the individual weights in the connection weight matrices. Instead of naïve finetuning of the connection weight matrices, transformer 140 was already finetuned by generating and finetuning multiple factor matrices 171A-B and 172A-B that each is orders of magnitude smaller than a connection weight matrix, referred to herein as factored finetuning. This factored finetuning entails three factor matrices for each neural layer, which were already generated by singular value decomposition (SVD) of the pretrained connection weight matrices. Herein, the three factor matrices are referred to as a left matrix that is a left singular vectors matrix, a diagonal matrix, and a right matrix that is a right singular vectors matrix. For example, factored finetuning of two neural layers 161-162 used six factor matrices whose elements were generated and modified during finetuning, including left matrices 171A and 172A and right matrices 171B and 172B.

The state of the art may generate a product matrix by multiplying together all of a left matrix, a diagonal matrix, and a right matrix. In the state of the art, there is no motivation to retain a factor matrix nor a product matrix after applying the product matrix at the end of finetuning. The approach herein does not implement or use a product matrix.

An embodiment may use any NLP, PEFT, or low-rank adaptation (LoRA) technique presented in “Lora: Low-rank adaptation of large language models” published by Hu, Edward J., et al in year 2021 in arXiv preprint arXiv: 2106.09685. that is incorporated in its entirety herein.

### 1.3 Novel Retention and Use of Factor Matrices

Herein, the left and right matrices are retained after finetuning, which is novel. Factor matrices 171A and 172A are respective left matrices of neural layers 151-152. Factor matrices 171A-B and 172A-B were already used to finetune transformer 140. LLM 110 contains factor matrices 171-172. Factor matrices 171A-B and 172A-B are used to generate layer outputs 161A-B and 162A-B.

Herein for production use (i.e. after finetuning, e.g. in a different environment), computer 100 uses some or all of factor matrices 171A-B and 172A-B to generate, based on input sequence of tokens 120, all of data structures 115, 130, 135, 181A-B, 182A-B, and 191-192. Embeddings 115, 181A-B, 182A-B, and 191-192 are novel, and Mahalanobis distance 130 is generated based on those novel embeddings. OOD detection is performed on sequence of tokens 120 based on Mahalanobis distance 130. In other words, using novel embeddings 115, 181A-B, 182A-B, and 191-192 is a new way to perform OOD detection as follows.

In operation, a neural layer retains and accumulates internal state as the neural layer processes tokens one after the other. In other words, previously processed tokens may affect processing of subsequent tokens. Thus, processing by a neural layer is contextual. For example, tokens 125A-B are transformed, by neural layer 151 and factor matrices 171A-B, into layer outputs 161A-B that are encoded tokens that correspond respectively to tokens 125A-B. In one example, tokens 125A-B are identical but layer outputs 161A-B are not identical due to contextual encoding.

### 1.4 Novel Embbedings of Token or Multiple Tokens

Layer output 161A is a neural activation generated by the shown neural pathway in which neural layer 151 activates when token 125A feeds forward through neural layer 151. Herein, neural activation by neural layer 151 feeds forward through, in sequence, both of factor matrices 171A-B as shown. That is, activation of factor matrix 171A generates activation output, shown as two token embeddings 181A-B, that factor matrix 171B sequentially uses as two activation inputs.

It is innovative to reuse (i.e. twice use) a same activation output (i.e. token embedding 181A or 181B) of a factor matrix, which computer 100 does as follows. Each of the two uses of, for example, token embedding 181A is for a different purpose along a different neural pathway, only one of which is a neural pathway as follows. Dataflow from factor matrix 171A to 171B occurs by neural connections inside transformer 140. Each of token embeddings 181A-B is a one-dimensional numeric array having a same fixed-size that is based on the size of factor matrix 171A.

Token embeddings 181A-B are combined to generate multi-token embedding 191 that is a one-dimensional numeric array having a same fixed-size as token embeddings 181A-B. In other words, each of embeddings 181A-B and 191 contain a same amount of numbers. Each number in token embedding 181A is individually combined with the corresponding (i.e. same array offset) number in token embedding 181B to generate a corresponding new number in multi-token embedding 191, such as by addition, averaging, or maximum value. For example for an input sequence of three tokens, each number in a multi-token embedding would be a combination of three numbers. In that way, multi-token embedding 191 represents the whole sequence of tokens 120.

Layer outputs 162A-B are generated using factor matrices 172A-B as described above, and generation of multi-token embedding 192 is as described. Multi-token embeddings 191-192 are not identical even though each individually is a semantic and contextual embedding that represents same sequence of tokens 120. In other words, each of multi-token embeddings 191-192 characterizes: a) sequence of tokens 120 and b) what was the learned reaction (i.e. activation) to sequence of tokens 120 by a respective neural layer.

### 1.5 Novel Multilayer Embedding

Multi-token embeddings 191-192 are concatenated to generate multilayer embedding 115 that is a numeric array whose fixed size (i.e. element count) is the sum of the sizes of the multi-token embeddings contained in multilayer embedding 115. Multilayer embedding 115 a fixed-size semantic and contextual embedding.

Each of embeddings 115 and 191-192 is distinct even though they each individually represent and characterize same sequence of tokens 120. Due to generation by concatenation, multilayer embedding 115 contains some numbers that are based on neural layer 152 and some numbers that are not based on neural layer 152.

In the state of the art, sequence of tokens 120 may be analytically compared to a reference (e.g. training) corpus to perform OOD detection. If sequence of tokens 120 is dissimilar (i.e. out of distribution, OOD) from the data distribution of the training corpus, then ML models 110 and 140 were not trained to process sequence of tokens 120, which means that sequence of tokens 120 is extraordinary.

Because multilayer embedding 115 characterizes the finetuned reaction of transformer 140 to sequence of tokens 120, multilayer embedding 115 is used to detect whether or not transformer 140 was finetuned with data similar to sequence of tokens 120. Thus, multilayer embedding 115 is used to detect whether sequence of tokens 120 is or is not OOD for the specific application that models 110 and 140 were finetuned for.

### 1.6 Finetuning Postprocess Generates Covariance Matrix

OOD detection herein does not use a reference corpus, which may already have been discarded or may otherwise be unavailable. Thus, OOD detection herein consumes less time and space of computer 100 than a technique that uses a reference corpus. Indeed, generating Mahalonobis distance 130 from layer outputs 161A-B and 162A-B is computationally efficient as follows.

By a finetuning computer (e.g. not computer 100), covariance matrix 135 was already generated during finetuning and before the finetuning corpus is, for example, discarded. In other words, covariance matrix 135 was already predefined as follows.

Soon after finetuning, the finetuning computer (not shown) performs a novel finetuning postprocess that generates a multi-token embedding for each sequence of tokens in the finetuning corpus as follows. This finetuning postprocess reuses the finetuning corpus again as inputs for transformer 140 but without backpropagation and without, as discussed earlier herein, modifying factor matrices. During this finetuning postprocess, components 110 and 140 and the finetuned factor matrices 171A-B and 172A-B are immutable (i.e. read only).

The finetuning postprocess operates transformer 140 that may be operated without LLM 110 even if LLM 110 participated in finetuning. Using factor matrices 171A and 172A to generate a multilayer embedding as discussed earlier herein is performed for each sequence of tokens in the finetuning corpus.

The finetuning postprocess generates covariance matrix 135 from all of the multilayer embeddings generated from factor matrices 171A and 172A. Each distinct array offset in the multilayer embeddings is a distinct dimension. Covariance matrix 135 is a square matrix. For example if each of multiple multilayer embeddings is an array of ten numbers, then covariance matrix 135 has a diagonal that consists of ten numbers.

The finetuning postprocess generates covariance matrix 135 and a corresponding statistical mean (i.e. average) from the multilayer embeddings. The mean is a multidimensional mean that is a vector that is a numeric array that contains a same count of numbers as the multilayer embeddings each contains. For example when the diagonal is ten for covariance matrix 135, then the multidimensional mean consists of ten scalar means.

### 1.7 Mahalanobis Distance for Ood Detection

In that way, covariance matrix 135 was predefined by the finetuning postprocess. For example, computer 100 may receive predefined covariance matrix 135 and finetuned components 140, 171A-B, and 172A-B as archived by the finetuning process and postprocess of the finetuning computer. In some contexts herein, finetuning may mean both of the finetuning process and postprocess.

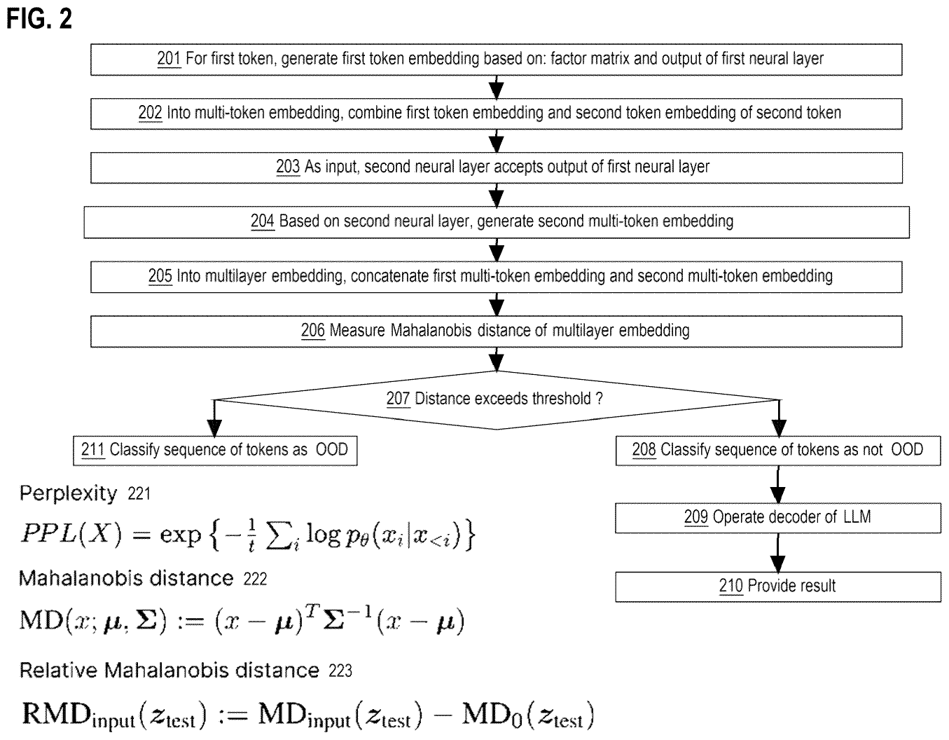

Computer 100 measures Mahalanobis distance 130 according to either of Mahalanobis distance 222-223 formulae shown in FIG. 2 that also shows a perplexity 221 formula. Perplexity is discussed above in the Background. Formulae 221-223 use the following terms that were generated and retained in different lifecycle phases of LLM 110 as follows. DO is a background corpus that, for example, existed since before finetuning, and Dinput is the finetuning corpus. X, x, and z are live data or a test corpus. The following terms are generated during finetuning and retained.
multidimensional mean u
Σ is covariance matrix 135

Each of Mahalanobis distance 222-223 formulae returns a multidimensional distance as a multiple scalar distances for multiple dimensions. The sum of those scalar distances is Mahalanobis distance 130 that is a single scalar magnitude (i.e. number).

OOD detection for sequence of tokens 120 entails detecting whether or not Mahalanobis distance 130 exceeds a predefined threshold. If the threshold is exceeded, then ML models 110 and 140 were not trained to process sequence of tokens 120. In one example, ML models 110 and 140 were finetuned to process English natural language, and tokens 125A-B may be Spanish words that cause OOD to be detected. In another example, ML models 110 and 140 were finetuned to process scientific publications, and sequence of tokens 120 instead is poetry that causes OOD to be detected.

1.8 OOD Detection Integrated into Application

OOD detection may be important for various reasons. Because ML models 110 and 140 were not trained to process an OOD input, ML models 110 and 140 may inferentially generate very wrong (i.e. inaccurate) output for the OOD input that might cause or contribute to various problems such as: a) a malfunction of downstream automation, b) misleading of a human user, or c) intentional abuse of ML model 110 or 140 such as d) exfiltration of training data, model configuration, or model architecture or c) use of ML model 110 or 140 in violation of a voluntary restriction of subject matter or scope. For example, the user might have agreed not to use LLM 110 for advice on medical, financial, legal, or physical safety issues, and LLM 110 was not finetuned for such advice. In those various cases, it may be better to automatically discard or prevent generation of the output of ML models 110 and 140 instead of providing the output to a user or downstream automation.

For example if sequence of tokens 120 is detected as OOD, then computer 100 may reject sequence of tokens 120 even if ML model 110 or 140 already processed sequence of tokens 120. For example, sequence of tokens 120 may be a natural language question that, based on Mahalanobis distance 130, computer 100 automatically refuses to answer. In another example, detection of OOD may cause retraining (e.g. repeated finetuning) of ML model 110 or 140. For example, computer 100 may add OOD sequence of tokens 120 to a finetuning corpus.

In an embodiment, ML models 110 and 140 expect that sequence of tokens 120 is not natural language but instead is a computer programing language. In an embodiment, ML models 110 and 140 expect that sequence of tokens 120 is not for a language but instead is a sequence of events or data fields. For example, sequence of tokens 120 may be a stream of simple API for XML (SAX) events or a stream of telemetry such as a timeseries.

### 2.0 Example Out of Distribution (Ood) Detection Process

FIG. 2 is a flow diagram that depicts an example process that computer 100 may perform to detect whether or not sequence of tokens 120 is out of distribution (OOD).

Factor matrices 171A-B and 172A-B and covariance matrix 135 may be predefined parts of a component referred to herein as an OOD detector that measures Mahalanobis distance 130 of sequence of tokens 120 based on layer outputs 161A-B and 162A-B. In an embodiment, neural layer 152, the OOD detector, and the process of FIG. 2 do not operate until all layer outputs 161A-B were generated and neural layer 151 has finished encoding the entire sequence of tokens 120. The OOD detector performs steps 201-202, 204-208, and 211. Neural layer 152 performs step 203. Large language model (LLM) 110 performs step 209. Computer 100 performs step 210. The process of FIG. 2 can be performed without accessing a finetuning corpus as follows.

For token 125A as discussed earlier herein, step 201 generates token embedding 181A based on factor matrix 171A as activated by neural layer 151.

Step 202 combines token embeddings 181A-B into multi-token embedding 191 as discussed earlier herein. Layer outputs 161A-B that collectively represent the entire sequence of tokens 120 are accepted as input by neural layer 152 in step 203 as discussed earlier herein.

Step 204 generates multi-token embedding 192 as discussed earlier herein. Step 205 concatenates multi-token embeddings 191-192 into multilayer embedding 115 as discussed earlier herein.

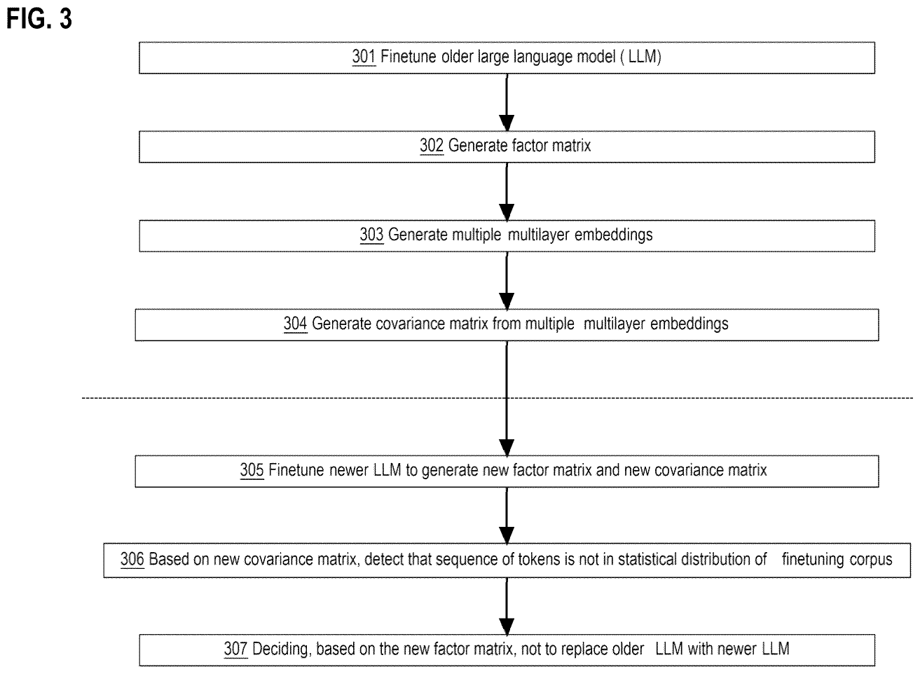

As discussed earlier for FIG. 1 and later for FIG. 3, the finetuning postprocess already fit a Gaussian to generate a predefined multidimensional statistical mean and predefined covariance matrix 135. Step 206 measures Mahalanobis distance 130 based on covariance matrix 135 and the statistical mean. Step 206 measures Mahalanobis distance 130 as a scalar numeric sum (i.e. non-negative real number) by summation as discussed earlier herein. Summation may entail squaring or taking the absolute value of the numbers. For example, a Euclidian distance formula may be used.

Step 207 detects whether or not Mahalanobis distance 130 exceeds a predefined threshold that is a positive real number. If the threshold is exceeded, step 211 occurs as discussed later herein. If the threshold is not exceeded, steps 208-210 occur instead as follows.

Step 208 classifies sequence of tokens 120 as not OOD. For example, binary classification may detect a positive class (i.e. OOD) or, in the case of step 208, a negative class (i.e. not OOD). For example, step 208 may be a precondition of ordinary further processing by the process of FIG. 2 and, for example, by downstream automation.

As discussed earlier herein, LLM 110 may comprise a (e.g. generative) decoder ML model that accepts, as input, the output of transformer 140 that represents the entire sequence of tokens 120. The decoder inferentially generates a result in step 209. If the decoder is a classifier, the result is an inferred class. If the decoder is a regression, the result is a number such as a score. If the decoder is a natural language generator, the result is prose such as a natural sentence or paragraph. For example, a generative decoder may perform summarization.

Computer 100 provides the result to a user or to downstream automation in step 210, after which the process of FIG. 10 ceases.

If step 207 detected that Mahalanobis distance 130 exceeded the threshold, then step 211 classifies sequence of tokens 120 as OOD. In that case: a) steps 208-210 do not occur, b) the decoder does not operate, c) LLM 110 does not generate a result, and d) no result is provided to the user or downstream automation. Step 211 may perform none, some, or all of: a) indicate an error to the user or downstream automation, b) initiate special handling of sequence of tokens 120, and c) archive sequence of tokens 120 for later special handling such as forensics or retraining.

The overall accuracy of steps 207-208 and 211 is unprecedented (i.e. increased). For near OOD (i.e. OOD near step 207's decision boundary, i.e. Mahalanobis distance 130 only slightly exceeding the predefined threshold), the accuracy of steps 207 and 211 is unprecedented. For example unlike this approach, state of the art OOD detection is prone to false negatives near a state of the art decision boundary. In other words, increase of the true positive rate (TPR) by steps 207 and 211 is unprecedented. In those ways, increase of the accuracy of internal operation of components 100, 110, and 140 by the process of FIG. 2 is unprecedented.

### 3.0 Example Software Development Lifecycle (SDLC)

FIG. 3 is a flow diagram that depicts an example process performed by one or more computers to finetune and compare different versions of LLM 110.

FIG. 3 depicts two scenarios that are finetuning as discussed earlier herein and acceptance testing of LLM 110. Above the shown horizontal dashed line are steps 301-304 of the finetuning scenario, and below the horizontal dashed line are steps 305-307 of the acceptance testing scenario.

As discussed earlier herein, finetuning entails a finetuning process and a finetuning postprocess. The finetuning process entails steps 301-302. The finetuning postprocess entails steps 303-304. Acceptance testing entails steps 305-307.

As discussed earlier herein, ML model 110 or 140 has a lifecycle that entails a pretraining phase followed by a finetuning phase followed, after deployment into a production environment, by a duty phase. Those phases may occur on a same or different computers in a same or different environments owned by a same or different enterprises. For example, a vendor may pretrain LLM 110, and a provider may finetune and deploy LLM 110 for a specific application. The vendor may repeatedly deliver improved versions of pretrained LLM 110, such as: a) a patch to fix a bug in the codebase of LLM 110, b) a result of a larger or better curated pretraining corpus, or c) a result of more or better pretraining task(s).

The example scenario shown above the horizontal dashed line finetunes an older version of LLM 110. The example scenario shown below the horizontal dashed line acceptance tests a newer version of LLM 110. Although those two scenarios may be separated by a long duration, both scenarios are interrelated as follows. In other words, a long duration may separate steps 304-305. The finetuning scenario is as follows.

During the finetuning scenario, the older version of LLM 100 is the current version. For example, the older version may be the latest version or the only version. Step 301 finetunes the older version of LLM 110 as discussed earlier herein.

For accelerated finetuning as discussed earlier herein, finetuning process step 302 is a sub-step of step 301. At the beginning of finetuning, step 302 generates factor matrices 171A-B and 172A-B by singular value decomposition (SVD) as discussed earlier herein. While finetuning is ongoing, step 302 modifies the numbers (i.e. numeric elements) in factor matrices 171A-B and 172A-B as discussed earlier herein.

As discussed earlier herein, the finetuning postprocess is novel. Finetuning postprocess steps 303-304 are sub-steps of step 301 that occur at the end of finetuning. Step 303 generates a respective multilayer embedding for each sequence of tokens in the finetuning corpus as discussed earlier herein.

As discussed earlier herein, step 304 generates covariance matrix 135 from a population that consists of the plurality of multilayer embeddings that step 303 generated.

Because pretraining is general and not application specific, it is possible that a newer version of LLM 110 may be better (i.e. more accurate) than an older version of LLM 110 for most but not all applications. For example, a particular application might have accuracy decreased by a newer version of LLM 110. The following acceptance testing scenario is a precaution to ensure that the new version does not cause the performance (i.e. accuracy) of LLM 110 to regress (i.e. decrease compared to the old version) for the particular application.

The acceptance testing scenario occurs when a pretrained new version of LLM 110 is received, for example, from a vendor. Step 305 finetunes the new version of LLM 110. In other words, step 305 performs, as sub-steps, all of finetuning steps 301-304 again, but using the new version of LLM 110 instead of the old version of LLM 110 that is still in service. Thus, the old version of LLM 110 is used with an old version of components 135, 171A-B, and 172A-B, and step 305 generates a new version of components 135, 171A-B, and 172A-B.

Although steps 301 and 305 finetune different respective versions of LLM 110, steps 301 and 305 may or may not use a same finetuning corpus. In one example, computer 100 may continue to operate the old version of LLM 110 in a production environment while a finetuning computer in a laboratory environment performs finetuning step 305 and, as follows, acceptance testing steps 306-307.

Herein, finetuning is supervised or self-supervised. Finetuning steps 301 and 305 may each be followed by a validation step (not shown) that uses a labeled validation corpus (i.e. not the finetuning corpus) to measure a validation score of the old or new version of LLM 110, and the validation step may use a same or different validation corpus respectively for the old and new versions of LLM 110. Unlike state of the art validation: a) the validation score is based on Mahalanobis distance 130, and b) the validation score is based on novel embeddings 115, 181A-B, 182A-B, and 191-192.

Herein, supervised validation may entail a heterogeneous corpus that contains a balanced or imbalanced mix of positives (i.e. OODs) and negatives or may entail a homogenous corpus that contains only positives or only negatives. Herein, unsupervised validation entails an unlabeled validation corpus that has an extremely low contamination factor (i.e. almost only negatives).

A heterogenous (i.e. two class, positive and negative) validation corpus may be used to populate a confusion matrix as follows. The validation score may comprise or be based on part or all of a confusion matrix based on thresholding step 207 in FIG. 2. For example, if the validation corpus labels sequence of tokens 120 as positive (i.e. OOD), then: a) a true positive is when Mahalanobis distance 130 exceeds the predefined threshold, in which case step 306 correctly classifies sequence of tokens 120 as OOD, and b) a false negative is when Mahalanobis distance 130 does not exceed the predefined threshold. Conversely, if the validation corpus instead labels sequence of tokens 120 as negative, then: a) a false positive is when Mahalanobis distance 130 exceeds the predefined threshold, in which case step 306 incorrectly classifies sequence of tokens 120 as OOD, and b) a true negative is when Mahalanobis distance 130 does not exceed the predefined threshold.

A homogenous (i.e. single class or unlabeled extremely low contamination) validation corpus may be operated without thresholding step 207. That is, homogenous validation herein does not use a threshold. Homogenous validation instead measures the statistical mean of Mahalanobis distances of all sequences of tokens in the homogenous corpus. If the homogenous corpus is single class, then arithmetic mean is used as the validation score that is better when: a) lower if negative is the single class or b) higher if positive is the single class. If the homogenous corpus is unlabeled and almost uncontaminated, then harmonic mean is used as the validation score that is better when lower.

In those ways, one validation score may be better (e.g. higher) than another validation score, and the acceptance testing scenario is able to detect which of the old and new versions of LLM 110 is better. For example, the validation score of the old version may have been retained since before availability of the new version and, if the validation score of the new version is less than the old validation score, then: a) detection that performance (i.e. accuracy) of the new version of LLM 110 has regressed is automatic, and b) detection that the new version of LLM 110 fails the acceptance test is automatic, and c) step 307 may entail an automatic or manual decision not to replace the old version of LLM 110 with the new version, in which case the new version may be discarded. Conversely if the acceptance test passes, the new version may be deployed into service to replace the old version, in which case the old version may be discarded.

Regardless of whether the acceptance test passes or fails: a) the more accurate version of LLM 110 is selected, and b) the effect of that model selection is that the accuracy of components 100, 110, and 140 is maximized. Thus, regardless of whether the acceptance test passes or fails, the accuracy of components 100, 110, and 140 is increased by validation based on novel embeddings 115, 181A-B, 182A-B, and 191-192. In other words, regardless of whether the acceptance test passes or fails, the embedding-based acceptance testing herein is a new way to increase the accuracy of internal operation of components 100, 110, and 140.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

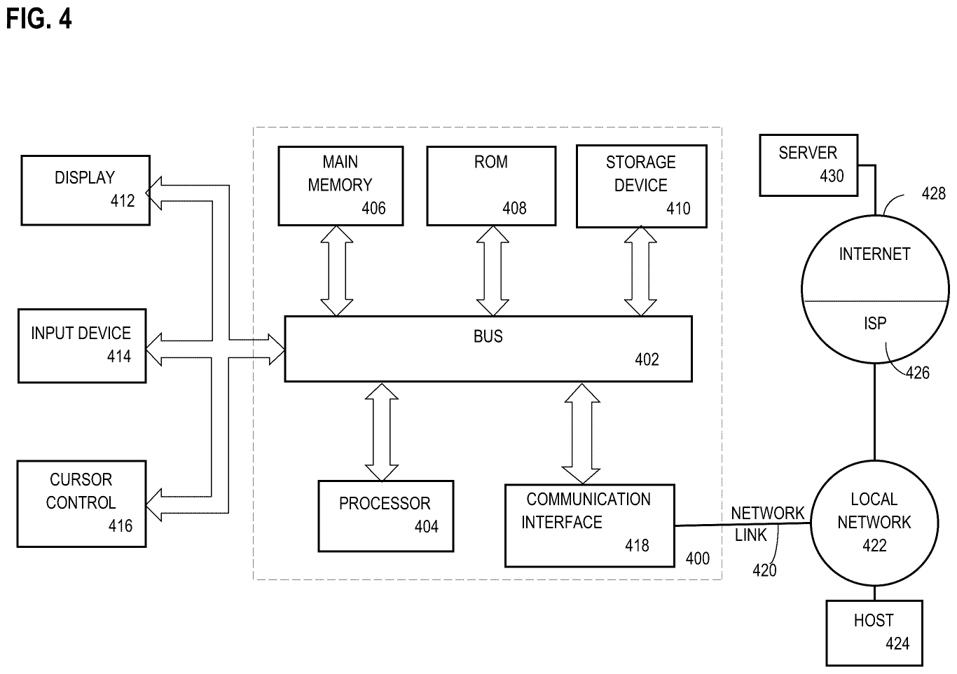

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or solid-state drive is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 410. Volatile media includes dynamic memory, such as main memory 406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

### Software Overview

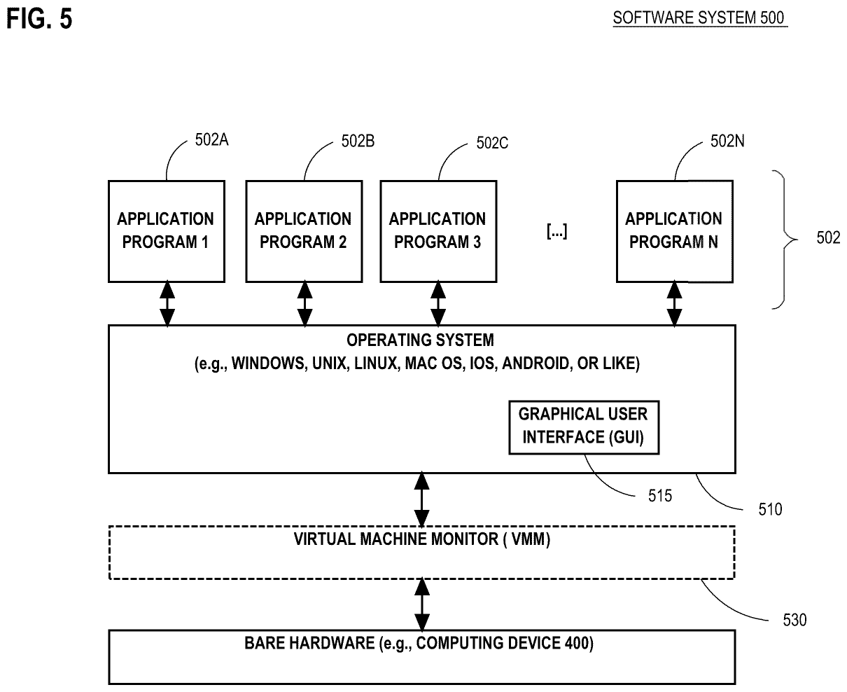

FIG. 5 is a block diagram of a basic software system 500 that may be employed for controlling the operation of computing system 400. Software system 500 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 500 is provided for directing the operation of computing system 400. Software system 500, which may be stored in system memory (RAM) 406 and on fixed storage (e.g., hard disk or flash memory) 410, includes a kernel or operating system (OS) 510.

The OS 510 manages low-level aspects of computer operation, including managing execution of processes, memory allocation, file input and output (I/O), and device I/O. One or more application programs, represented as 502A, 502B, 502C . . . 502N, may be “loaded” (e.g., transferred from fixed storage 410 into memory 406) for execution by the system 500. The applications or other software intended for use on computer system 400 may also be stored as a set of downloadable computer-executable instructions, for example, for downloading and installation from an Internet location (e.g., a Web server, an app store, or other online service).

Software system 500 includes a graphical user interface (GUI) 515, for receiving user commands and data in a graphical (e.g., “point-and-click” or “touch gesture”) fashion. These inputs, in turn, may be acted upon by the system 500 in accordance with instructions from operating system 510 and/or application(s) 502. The GUI 515 also serves to display the results of operation from the OS 510 and application(s) 502, whereupon the user may supply additional inputs or terminate the session (e.g., log off).

OS 510 can execute directly on the bare hardware 520 (e.g., processor(s) 404) of computer system 400. Alternatively, a hypervisor or virtual machine monitor (VMM) 530 may be interposed between the bare hardware 520 and the OS 510. In this configuration, VMM 530 acts as a software “cushion” or virtualization layer between the OS 510 and the bare hardware 520 of the computer system 400.

VMM 530 instantiates and runs one or more virtual machine instances (“guest machines”). Each guest machine comprises a “guest” operating system, such as OS 510, and one or more applications, such as application(s) 502, designed to execute on the guest operating system. The VMM 530 presents the guest operating systems with a virtual operating platform and manages the execution of the guest operating systems.

In some instances, the VMM 530 may allow a guest operating system to run as if it is running on the bare hardware 520 of computer system 400 directly. In these instances, the same version of the guest operating system configured to execute on the bare hardware 520 directly may also execute on VMM 530 without modification or reconfiguration. In other words, VMM 530 may provide full hardware and CPU virtualization to a guest operating system in some instances.

In other instances, a guest operating system may be specially designed or configured to execute on VMM 530 for efficiency. In these instances, the guest operating system is “aware” that it executes on a virtual machine monitor. In other words, VMM 530 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprise two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure and applications.

The above-described basic computer hardware and software and cloud computing environment presented for purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### Machine Learning Models

A machine learning model is trained using a particular machine learning algorithm. Once trained, input is applied to the machine learning model to make a prediction, which may also be referred to herein as a predicated output or output. Attributes of the input may be referred to as features and the values of the features may be referred to herein as feature values.

A machine learning model includes a model data representation or model artifact. A model artifact comprises parameters values, which may be referred to herein as theta values, and which are applied by a machine learning algorithm to the input to generate a predicted output. Training a machine learning model entails determining the theta values of the model artifact. The structure and organization of the theta values depends on the machine learning algorithm.

In supervised training, training data is used by a supervised training algorithm to train a machine learning model. The training data includes input and a “known” output. In an embodiment, the supervised training algorithm is an iterative procedure. In each iteration, the machine learning algorithm applies the model artifact and the input to generate a predicated output. An error or variance between the predicated output and the known output is calculated using an objective function. In effect, the output of the objective function indicates the accuracy of the machine learning model based on the particular state of the model artifact in the iteration. By applying an optimization algorithm based on the objective function, the theta values of the model artifact are adjusted. An example of an optimization algorithm is gradient descent. The iterations may be repeated until a desired accuracy is achieved or some other criteria is met.

In a software implementation, when a machine learning model is referred to as receiving an input, being executed, and/or generating an output or predication, a computer system process executing a machine learning algorithm applies the model artifact against the input to generate a predicted output. A computer system process executes a machine learning algorithm by executing software configured to cause execution of the algorithm. When a machine learning model is referred to as performing an action, a computer system process executes a machine learning algorithm by executing software configured to cause performance of the action.

Inferencing entails a computer applying the machine learning model to an input such as a feature vector to generate an inference by processing the input and content of the machine learning model in an integrated way. Inferencing is data driven according to data, such as learned coefficients, that the machine learning model contains. Herein, this is referred to as inferencing by the machine learning model that, in practice, is execution by a computer of a machine learning algorithm that processes the machine learning model.

Classes of problems that machine learning (ML) excels at include clustering, classification, regression, anomaly detection, prediction, and dimensionality reduction (i.e. simplification). Examples of machine learning algorithms include decision trees, support vector machines (SVM), Bayesian networks, stochastic algorithms such as genetic algorithms (GA), and connectionist topologies such as artificial neural networks (ANN). Implementations of machine learning may rely on matrices, symbolic models, and hierarchical and/or associative data structures. Parameterized (i.e. configurable) implementations of best of breed machine learning algorithms may be found in open source libraries such as Google's TensorFlow for Python and C++ or Georgia Institute of Technology's MLPack for C++. Shogun is an open source C++ ML library with adapters for several programing languages including C#, Ruby, Lua, Java, MatLab, R, and Python.

### Artificial Neural Networks

An artificial neural network (ANN) is a machine learning model that at a high level models a system of neurons interconnected by directed edges. An overview of neural networks is described within the context of a layered feedforward neural network. Other types of neural networks share characteristics of neural networks described below.

In a layered feed forward network, such as a multilayer perceptron (MLP), each layer comprises a group of neurons. A layered neural network comprises an input layer, an output layer, and one or more intermediate layers referred to hidden layers.

Neurons in the input layer and output layer are referred to as input neurons and output neurons, respectively. A neuron in a hidden layer or output layer may be referred to herein as an activation neuron. An activation neuron is associated with an activation function. The input layer does not contain any activation neuron.

From each neuron in the input layer and a hidden layer, there may be one or more directed edges to an activation neuron in the subsequent hidden layer or output layer. Each edge is associated with a weight. An edge from a neuron to an activation neuron represents input from the neuron to the activation neuron, as adjusted by the weight.

For a given input to a neural network, each neuron in the neural network has an activation value. For an input neuron, the activation value is simply an input value for the input. For an activation neuron, the activation value is the output of the respective activation function of the activation neuron.

Each edge from a particular neuron to an activation neuron represents that the activation value of the particular neuron is an input to the activation neuron, that is, an input to the activation function of the activation neuron, as adjusted by the weight of the edge. Thus, an activation neuron in the subsequent layer represents that the particular neuron's activation value is an input to the activation neuron's activation function, as adjusted by the weight of the edge. An activation neuron can have multiple edges directed to the activation neuron, each edge representing that the activation value from the originating neuron, as adjusted by the weight of the edge, is an input to the activation function of the activation neuron.

Each activation neuron is associated with a bias. To generate the activation value of an activation neuron, the activation function of the neuron is applied to the weighted activation values and the bias.

### Illustrative Data Structures for Neural Network

The artifact of a neural network may comprise matrices of weights and biases. Training a neural network may iteratively adjust the matrices of weights and biases.

For a layered feedforward network, as well as other types of neural networks, the artifact may comprise one or more matrices of edges W. A matrix W represents edges from a layer L−1 to a layer L. Given the number of neurons in layer L−1 and L is N[L−1] and N[L], respectively, the dimensions of matrix W is N[L−1] columns and N[L] rows.

Biases for a particular layer L may also be stored in matrix B having one column with N[L] rows.

The matrices W and B may be stored as a vector or an array in RAM memory, or comma separated set of values in memory. When an artifact is persisted in persistent storage, the matrices W and B may be stored as comma separated values, in compressed and/serialized form, or other suitable persistent form.

A particular input applied to a neural network comprises a value for each input neuron. The particular input may be stored as vector. Training data comprises multiple inputs, each being referred to as sample in a set of samples. Each sample includes a value for each input neuron. A sample may be stored as a vector of input values, while multiple samples may be stored as a matrix, each row in the matrix being a sample.

When an input is applied to a neural network, activation values are generated for the hidden layers and output layer. For each layer, the activation values for may be stored in one column of a matrix A having a row for every neuron in the layer. In a vectorized approach for training, activation values may be stored in a matrix, having a column for every sample in the training data.

Training a neural network requires storing and processing additional matrices. Optimization algorithms generate matrices of derivative values which are used to adjust matrices of weights W and biases B. Generating derivative values may use and require storing matrices of intermediate values generated when computing activation values for each layer.

The number of neurons and/or edges determines the size of matrices needed to implement a neural network. The smaller the number of neurons and edges in a neural network, the smaller matrices and amount of memory needed to store matrices. In addition, a smaller number of neurons and edges reduces the amount of computation needed to apply or train a neural network. Less neurons means less activation values need be computed, and/or less derivative values need be computed during training.

Properties of matrices used to implement a neural network correspond neurons and edges. A cell in a matrix W represents a particular edge from a neuron in layer L−1 to L. An activation neuron represents an activation function for the layer that includes the activation function. An activation neuron in layer L corresponds to a row of weights in a matrix W for the edges between layer L and L−1 and a column of weights in matrix W for edges between layer L and L+1. During execution of a neural network, a neuron also corresponds to one or more activation values stored in matrix A for the layer and generated by an activation function.

An ANN is amenable to vectorization for data parallelism, which may exploit vector hardware such as single instruction multiple data (SIMD), such as with a graphical processing unit (GPU). Matrix partitioning may achieve horizontal scaling such as with symmetric multiprocessing (SMP) such as with a multicore central processing unit (CPU) and or multiple coprocessors such as GPUs. Feed forward computation within an ANN may occur with one step per neural layer. Activation values in one layer are calculated based on weighted propagations of activation values of the previous layer, such that values are calculated for each subsequent layer in sequence, such as with respective iterations of a for loop. Layering imposes sequencing of calculations that is not parallelizable. Thus, network depth (i.e. amount of layers) may cause computational latency. Deep learning entails endowing a multilayer perceptron (MLP) with many layers. Each layer achieves data abstraction, with complicated (i.e. multidimensional as with several inputs) abstractions needing multiple layers that achieve cascaded processing. Reusable matrix based implementations of an ANN and matrix operations for feed forward processing are readily available and parallelizable in neural network libraries such as Google's TensorFlow for Python and C++, OpenNN for C++, and University of Copenhagen's fast artificial neural network (FANN). These libraries also provide model training algorithms such as backpropagation.

### Backpropagation

An ANN's output may be more or less correct. For example, an ANN that recognizes letters may mistake an I as an L because those letters have similar features. Correct output may have particular value(s), while actual output may have somewhat different values. The arithmetic or geometric difference between correct and actual outputs may be measured as error according to a loss function, such that zero represents error free (i.e. completely accurate) behavior. For any edge in any layer, the difference between correct and actual outputs is a delta value.

Backpropagation entails distributing the error backward through the layers of the ANN in varying amounts to all of the connection edges within the ANN. Propagation of error causes adjustments to edge weights, which depends on the gradient of the error at each edge. Gradient of an edge is calculated by multiplying the edge's error delta times the activation value of the upstream neuron. When the gradient is negative, the greater the magnitude of error contributed to the network by an edge, the more the edge's weight should be reduced, which is negative reinforcement. When the gradient is positive, then positive reinforcement entails increasing the weight of an edge whose activation reduced the error. An edge weight is adjusted according to a percentage of the edge's gradient. The steeper is the gradient, the bigger is adjustment. Not all edge weights are adjusted by a same amount. As model training continues with additional input samples, the error of the ANN should decline. Training may cease when the error stabilizes (i.e. ceases to reduce) or vanishes beneath a threshold (i.e. approaches zero). Example mathematical formulae and techniques for feedforward multilayer perceptron (MLP), including matrix operations and backpropagation, are taught in related reference “EXACT CALCULATION OF THE HESSIAN MATRIX FOR THE MULTI-LAYER PERCEPTRON,” by Christopher M. Bishop.

Model training may be supervised or unsupervised. For supervised training, the desired (i.e. correct) output is already known for each example in a training set. The training set is configured in advance by (e.g. a human expert) assigning a categorization label to each example. For example, the training set for optical character recognition may have blurry photographs of individual letters, and an expert may label each photo in advance according to which letter is shown. Error calculation and backpropagation occurs as explained above.

### Autoencoder

Unsupervised model training is more involved because desired outputs need to be discovered during training. Unsupervised training may be easier to adopt because a human expert is not needed to label training examples in advance. Thus, unsupervised training saves human labor. A natural way to achieve unsupervised training is with an autoencoder, which is a kind of ANN. An autoencoder functions as an encoder/decoder (codec) that has two sets of layers. The first set of layers encodes an input example into a condensed code that needs to be learned during model training. The second set of layers decodes the condensed code to regenerate the original input example. Both sets of layers are trained together as one combined ANN. Error is defined as the difference between the original input and the regenerated input as decoded. After sufficient training, the decoder outputs more or less exactly whatever is the original input.

An autoencoder relies on the condensed code as an intermediate format for each input example. It may be counter-intuitive that the intermediate condensed codes do not initially exist and instead emerge only through model training. Unsupervised training may achieve a vocabulary of intermediate encodings based on features and distinctions of unexpected relevance. For example, which examples and which labels are used during supervised training may depend on somewhat unscientific (e.g. anecdotal) or otherwise incomplete understanding of a problem space by a human expert. Whereas, unsupervised training discovers an apt intermediate vocabulary based more or less entirely on statistical tendencies that reliably converge upon optimality with sufficient training due to the internal feedback by regenerated decodings. Techniques for unsupervised training of an autoencoder for anomaly detection based on reconstruction error is taught in non-patent literature (NPL) “VARIATIONAL AUTOENCODER BASED ANOMALY DETECTION USING RECONSTRUCTION PROBABILITY”, Special Lecture on IE. 2015 Dec. 27; 2 (1): 1-18 by Jinwon An et al.

### Principal Component Analysis

Principal component analysis (PCA) provides dimensionality reduction by leveraging and organizing mathematical correlation techniques such as normalization, covariance, eigenvectors, and eigenvalues. PCA incorporates aspects of feature selection by eliminating redundant features. PCA can be used for prediction. PCA can be used in conjunction with other ML algorithms.

### Random Forest

A random forest or random decision forest is an ensemble of learning approaches that construct a collection of randomly generated nodes and decision trees during a training phase. Different decision trees of a forest are constructed to be each randomly restricted to only particular subsets of feature dimensions of the data set, such as with feature bootstrap aggregating (bagging). Therefore, the decision trees gain accuracy as the decision trees grow without being forced to over fit training data as would happen if the decision trees were forced to learn all feature dimensions of the data set. A prediction may be calculated based on a mean (or other integration such as soft max) of the predictions from the different decision trees.

Random forest hyper-parameters may include: number-of-trees-in-the-forest, maximum-number-of-features-considered-for-splitting-a-node, number-of-levels-in-each-decision-tree, minimum-number-of-data-points-on-a-leaf-node, method-for-sampling-data-points, etc.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
generating a first token embedding based on: a factor matrix and an output of a neural layer that represents a first token in a sequence of tokens;
combining, into a multi-token embedding, the first token embedding and a second token embedding that is based on the factor matrix and a second token in the sequence of tokens; and
classifying, based on the multi-token embedding, the sequence of tokens.

2. The method of claim 1 wherein:
said multi-token embedding is a first multi-token embedding;
an artificial neural network contains the neural layer and a second neural layer;
the method further comprises:
generating, based on the second neural layer, a second multi-token embedding that represents the sequence of tokens, and
concatenating, into a multilayer embedding, the first multi-token embedding and the second multi-token embedding;
said classifying is based on the multilayer embedding.

3. The method of claim 1 wherein:
the method further comprises generating a plurality of multilayer embeddings;
each multilayer embedding of the plurality of multilayer embeddings is based on a distinct respective sequence of tokens;
the method further comprises generating a covariance matrix from the plurality of multilayer embeddings.

4. The method of claim 3 wherein said first fitting occurs during finetuning a large language model (LLM).

5. The method of claim 4 wherein:
said finetuning is based on a finetuning corpus;
said classifying comprises detecting, based on the covariance matrix, that the sequence of tokens is not in a statistical distribution of the finetuning corpus.

6. The method of claim 4 wherein:
said LLM is an old LLM that is older than a new LLM that contains the neural layer;
said factor matrix is an old factor matrix;
the method further comprises after said finetuning:
finetuning the new LLM to generate a new factor matrix, and
deciding, based on the new factor matrix, not to replace the old LLM with the new LLM.

7. The method of claim 1 not comprising accessing a finetuning corpus.

8. The method of claim 1 wherein:
the method further comprises generating a plurality of multi-token embeddings;
each multi-token embedding of the plurality of multi-token embeddings represents said sequence of tokens;
said classifying comprises:
concatenating, into a multilayer embedding, the plurality of multi-token embeddings, and
measuring a Mahalanobis distance of the multilayer embedding.

9. The method of claim 1 further comprising generating the factor matrix during finetuning an LLM.

10. The method of claim 1 wherein:
said classifying comprises detecting a threshold is not exceeded;
the method further comprises:
an LLM generating a result based on the output of the neural layer and a second output of the neural layer that represents the second token in the sequence of tokens;
providing the result only when the threshold is not exceeded.

11. The method of claim 1 further comprising:
a second neural layer accepting, as input, said output of the neural layer;
generating a multilayer embedding that contains:
a number that is based on the second neural layer and a number that is not based on the second neural layer.

12. One or more computer-readable non-transitory media storing instructions that, when executed by one or more processors, cause:
generating a first token embedding based on: a factor matrix and an output of an neural layer that represents a first token in a sequence of tokens;
combining, into a multi-token embedding, the first token embedding and a second token embedding that is based on the factor matrix and a second token in the sequence of tokens; and
classifying, based on the multi-token embedding, the sequence of tokens.

13. The one or more computer-readable non-transitory media of claim 12 wherein:
said multi-token embedding is a first multi-token embedding;
an artificial neural network contains the neural layer and a second neural layer;
the instructions further cause:
generating, based on the second neural layer, a second multi-token embedding that represents the sequence of tokens, and
concatenating, into a multilayer embedding, the first multi-token embedding and the second multi-token embedding;
said classifying is based on the multilayer embedding.

14. The one or more computer-readable non-transitory media of claim 12 wherein:
the instructions further cause generating a plurality of multilayer embeddings;
each multilayer embedding of the plurality of multilayer embeddings is based on a distinct respective sequence of tokens;
the instructions further cause generating a covariance matrix from the plurality of multilayer embeddings.

15. The one or more computer-readable non-transitory media of claim 14 wherein said first fitting occurs during finetuning a large language model (LLM).

16. The one or more computer-readable non-transitory media of claim 15 wherein:
said finetuning is based on a finetuning corpus;
said classifying comprises detecting, based on the covariance matrix, that the sequence of tokens is not in a statistical distribution of the finetuning corpus.

17. The one or more computer-readable non-transitory media of claim 15 wherein:
said LLM is an old LLM that is older than a new LLM that contains the neural layer;
said factor matrix is an old factor matrix;
the instructions further cause after said finetuning:
finetuning the new LLM to generate a new factor matrix, and
deciding, based on the new factor matrix, not to replace the old LLM with the new LLM.

18. The one or more computer-readable non-transitory media of claim 12 wherein the instruction do not cause accessing a finetuning corpus.

19. The one or more computer-readable non-transitory media of claim 12 wherein:
the instructions further cause generating a plurality of multi-token embeddings;
each multi-token embedding of the plurality of multi-token embeddings represents said sequence of tokens;
said classifying comprises:
concatenating, into a multilayer embedding, the plurality of multi-token embeddings, and
measuring a Mahalanobis distance of the multilayer embedding.

20. The one or more computer-readable non-transitory media of claim 12 wherein:
said classifying comprises detecting a threshold is not exceeded;
the instructions further cause:
an LLM generating a result based on the output of the neural layer and a second output of the neural layer that represents the second token in the sequence of tokens;
providing the result only when the threshold is not exceeded.
